(19) United States
(12) Patent Application Publication
(10) Pub. No.: US 2011/0116923 A1
(43) Pub. Date: May 19, 2011

(54) BLADE FOR A ROTOR OF A WIND OR WATER TURBINE

(76) Inventors: Helgi Larsen, Horsens (DK); Lars Larsen, Horsens (DK); Jan Allan Müller, Horsens (DK)

(21) Appl. No.: 12/994,893

(22) PCT Filed: May 27, 2009
(86) PCT No.: PCT/DK09/00117

§ 371 Date: Jan. 13, 2011

(30) Foreign Application Priority Data
May 27, 2008 (DK) PA 2008 00723

(51) Int. Cl. F01D 5/14; F03B 3/12; F03D 1/06

(52) U.S. Cl. 416/1; 416/235

(57) ABSTRACT

The present invention relates to a blade for a rotor of a wind turbine, which rotor comprises a hub, from which hub at least one blade extends substantially radially, which blade comprises a root area closest to the hub, which blade comprises a transition area away from the hub, which blade further comprises at least a first airfoil. The scope of the invention can be fulfilled by blades comprising at least one longitudinal channel, which channel has an inlet opening in the front of the airfoil, which channel has an outlet opening at the backside of the air foil, which channel opening area is decreasing from the inlet opening to the outlet opening. Hereby, it is achieved that in the channel there is an increasing speed of the air which is flowing through that channel which will lead to increasing the power produced from the wind surrounding the blade.

### FIELD OF THE INVENTION

The present invention relates to a blade for a rotor of a wind or water turbine, which rotor comprises a hub, from which hub at least one blade extends substantially radially, which blade comprises a root area closest to the hub, which blade comprises a transition area away from the hub, which blade comprises a pressure side and a low pressure side.

The present invention further relates to a method for converting energy from a flow in a media such as air or water into rotational energy by using at least one blade, which blade rotates around an axis, which blade is formed in radial direction in relation to the rotating axis, which blade comprises a pressure surface at which pressure surface the flowing media generates a pushing force at this pressure surface, and where the blade comprises a low pressure surface, where at the low pressure surface the media generates a pulling force.

### BACKGROUND OF THE INVENTION

WO 2007/045244 concerns a blade for a rotor of a wind turbine having a substantially horizontal rotor shaft, said rotor comprising a hub, from which the blade extends substantially radially from said rotor when mounted. The blade has a chord plane extending between the leading edge and the trailing edge of the blade. The blade comprises a root area closest to the hub, an airfoil area furthest away from the hub and a transition area between the root area and the airfoil area, and comprises a single airfoil along substantially the entire airfoil area. The blade comprises at least a first root segment and a second root segment along substantially the entire root area, said segments being arranged with a mutual distance, as seen transverse to the chord plane. At least one of the root segments has an airfoil profile.

WO 2007/057021A1 relates to a wind power plant with a first set with at least one blade mounted on a shaft and at least one second set with at least one blade mounted on the same shaft and mounted such that the blade sets will have the same direction of revolution and the same number of revolutions. The second set of blades has a length which is smaller than that of the first set of blades and has another optimal tip speed ratio than the first set of blades, whereby the two sets of blades are optimised with regard to power output at the same number of revolutions. The ratio between the lengths of the two sets of blades can be determined approximately by the ratio between the optimal tip speed ratios of the two sets of blades. Alternatively the second set of blades can be constructed to have an optimal tip speed ratio, which is determined on the basis of the ratio between the length of the two sets of blades and the optimal tip speed ratio for the one set of blades. The two or more sets of blades can be placed either right behind each other or in the same rotor plane and, according to the invention, the two sets of blades can be constituted by a small wind rose and a larger fast-runner. The invention further relates to use of such wind power plant.

WO 2007/105174 concerns rotor blades for large-sized horizontal axis wind turbines that allow easy transport, handling and storage at the same time guaranteeing greater efficiency in the use of wind energy. The present invention results in a blade made up of two or more elements arranged collaterally and preferably fixed among themselves such as to cause an aerodynamic interference between said elements.

### OBJECT OF THE INVENTION

It is the object of the invention to increase the power production from a wind or water turbine. A further object of the invention is to increase the power production of the slower rotating inner part of the blades.

### DESCRIPTION OF THE INVENTION

The scope of the invention can be fulfilled by blades as described in the preamble to claim 1 if at least one longitudinal channel is formed between the pressure side of the blade and the low pressure side of the blade, which channel has an inlet in the pressure side of the blade, which channel has an outlet in the low pressure side of the blade, which channel comprises an opening area, which opening area is decreasing from the inlet to the outlet.

Hereby, it is achieved that in the channel there is an increasing speed of the air or water which is flowing through that channel which will lead to increasing the power that is produced from the wind or water surrounding the blade. Especially, in the area near the hub of a blade near the rotating centre, the rotation speed is relatively slow and relatively little power or maybe no power is thus produced. If there is a longitudinal channel formed in the blade in the slowly rotating part, the power production in that part of the blade is rapidly increasing. Thereby, the power production from the blade of a wind turbine is not reduced to mainly coming from the outer third of a blade but also from the inner part of the blade. The use of a channel in a blade can increase the energy produced from that blade by more than 20%. The increasing power production is achieved without adding much weight to the blade and also without making the blade longer. Therefore, this invention leads to a highly efficient blade which can be used in almost all existing wind turbines if the blades are simply changed.

The channel can be formed between a secondary blade and the main blade, which secondary blade is placed at the front of the main blade at the low pressure side of the main blade. By placing the secondary blade at the front of the blade and parallel to the low pressure side of the blade, a flow channel is formed between the main blade and the secondary blade. This flow channel can be formed so that the distance between the primary and the secondary blade is slightly decreasing. This will lead to an increasing velocity of a media flowing through that channel. The increasing velocity will also increase the acting force which is acting at the front of the main blade. As well as media flowing along the secondary blade will also increase its speed as the travelling path length is now being somewhat longer because the media has to pass around the secondary blade. This also increases the force which is acting at the secondary blade. All in all, the increasing media speed will result in increasing energy consumption from the media.

The blade can comprise at least one longitudinal channel between the pressure side of the blade and the low pressure side of the blade, which channel has an inlet opening in the pressure side of the blade, which channel has an outlet opening in the low pressure side of the blade, which channel opening area is decreasing from the inlet opening to the outlet opening. As an alternative, the channel can be formed inside the main blade. This can be a preferred embodiment for blades in the future because new production facilities are necessary if blades are to be formed with channels. The effect of forming a channel in a blade is mostly the same as previously described. The media flowing through the channel will increase its speed as the distance between the walls of the channels are decreasing along the channel. This leads to an increasing speed of the media. Therefore, an acting force will be generated at the walls in the channel. When the media leaves the channel at a relatively high speed, this media will deflect the media passing around the blade without passing the channel. This media will be deflected in a way that increases the actual size of the blade. Therefore, the combined forces with are generated are increasing the power consumption from the media.

The channel can start near the root of the blade and continue to the end of the blade. Also near the end of a blade a narrow channel can result in increasing the energy consumption of the blade.

It is further preferred that the channel starts near the root of the blade and continues to at least ⅔ of the length of the blade. It is possible to achieve further improvements in the energy production by letting the length of the channel be up to the inner ⅔ of the blade. Further increasing the length of the blade is possible probably by slower rotating wind turbine blades. In some possible embodiments of the invention, the channel can go all the way to the front of the blade.

It is preferred that the channel starts near the root of the blade and continues to at least the middle of the length of the blade. The channel is most efficient in the inner part of the blade where the efficiency of the blade as such is reduced under normal conditions. Placing the channel in the inner part of the blade, the power production from the inner half of that blade will increase.

In a second embodiment for the invention, the blade can comprise two parallel longitudinal channels. Further improvement of the power production from a blade can be achieved if there are two parallel channels formed in the blade. The power production will probably be further increased if there is a second channel at least at the inner part near the hub where the first channel is somewhat longer in the direction somewhat closer to the outer end of the blade.

The channel is mainly formed by dividing the airfoil in a primary and a secondary blade between which the channel is formed.

The distance between the main blade and the secondary blade is preferably decreasing from the inlet towards the outlet opening. By reducing the opening of the channel, the air flowing through the channel will increase in speed. This increasing speed is the reason for the increasing power production. The air passing through the channel leaves the channel with a higher speed than the surrounding air which leads to further energy production of the area of the main airfoil as the speed of air is higher than usual. The difference in the speed of air between air passing below the blade and air passing above the blade is the cause of the energy produced in the blade. Therefore, the increasing speed of air would lead to higher energy production.

At least one channel can be formed in relation to the blade, which channel has an inlet at the pressure side of the blade and an outlet in the low pressure side. Placing a channel at the slow rotating part of a blade in the area that is closest to the hub, this inner area of the blade will increase its effectively. Maybe the channel only has to be placed in the inner third of the length of a blade to be fully effective. A typical blade is designed for being highly effective at the fast rotating outer part of the blade. Therefore, the inner part of the blade is constructed in a way where material strength for supporting the highly effective outer part is more important than the correct aerodynamic design. Therefore, the aerodynamics is not perfect at the inner part of a blade. Placing a channel in the inner part of the blade will increase the effectively of the inner part of the blade, thus compensating for a bad aerodynamic construction. In fact, placing one or two channels in one or another possible way at the inner part of the blade, it is possible to increase the power produced up to 20%. An even higher increase is possible if the design of channels and blades is performed in a computer simulation, and a new blade is designed according to this computer simulation.

### DESCRIPTION OF THE DRAWING

FIG. 1 shows a first possible embodiment of the invention, and

FIG. 2 shows the same embodiment as FIG. 1 but seen from the opposite side, and

FIG. 3 shows a sectional view of a possible embodiment of the invention, and

FIG. 4 shows an enlarged side view which is sectional in the end.

FIG. 5 shows three blades which are connected to a hub.

FIG. 6 shows a sectional view A-A of the blade.

FIG. 7 shows the same elements as previously described in FIG. 6.

FIG. 8 shows a blade 102 seen from the low pressure side.

FIG. 9 shows an alternative embodiment to the invention.

FIG. 10 shows a sectional view of an alternative embodiment for a blade.

FIG. 11 shows a blade from the alternative embodiment seen from the low pressure side.

### DETAILED DESCRIPTION OF THE INVENTION

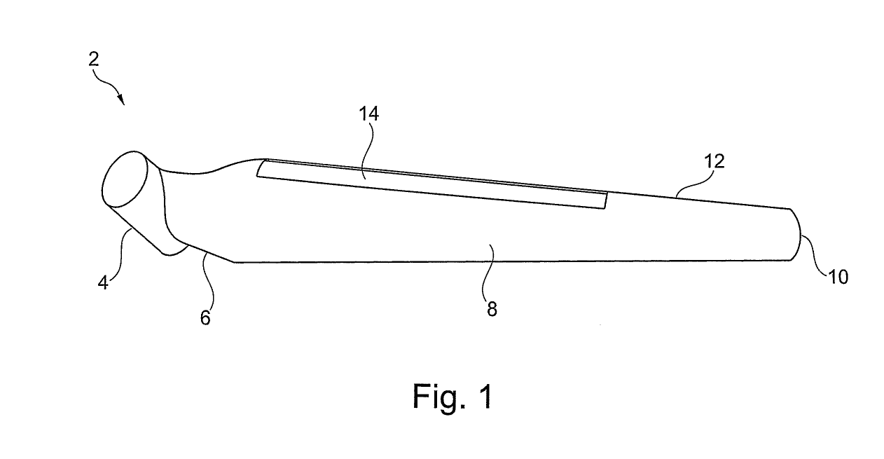

FIG. 1 shows a blade 2 for a wind or water turbine. The blade is seen from the low pressure side 8 of the blade 2. The blade 2 comprises a root connection 4 and a transition area 6. The transition area 6 continues into the low pressure side 8 of the blade. The blade 2 continues into the end 10. The pressure side 16 of the blade 2 comprises the inlet 14 for the longitudinal channel 18.

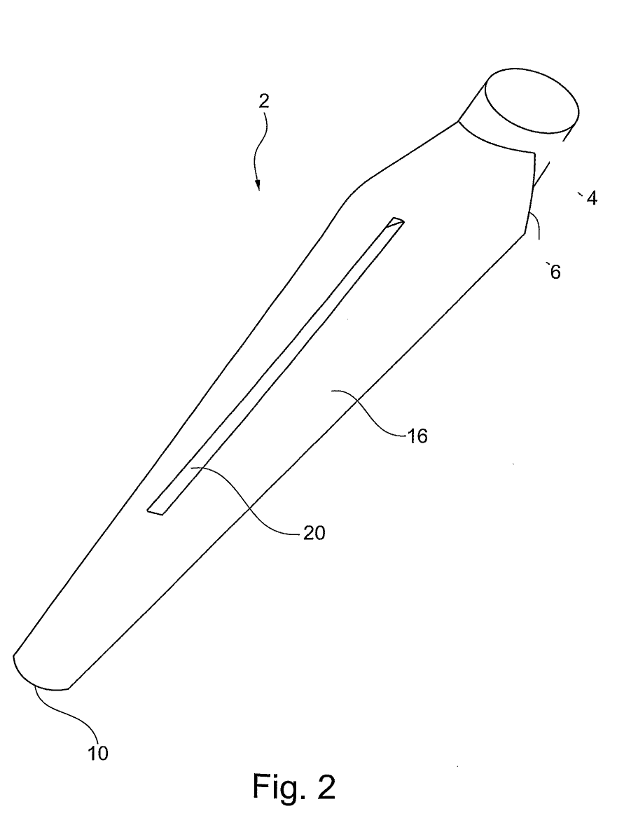

FIG. 2 shows the same embodiment as FIG. 1, but seen from the pressure side 16. The root connection 4 is connected to the blade 2 by the transition area 6 which blade 2 has an end 10. The pressure side 16 of the blade 2 comprises the outlet opening 20 for the channel 18 which channel 18, in FIG. 1, has the inlet 14.

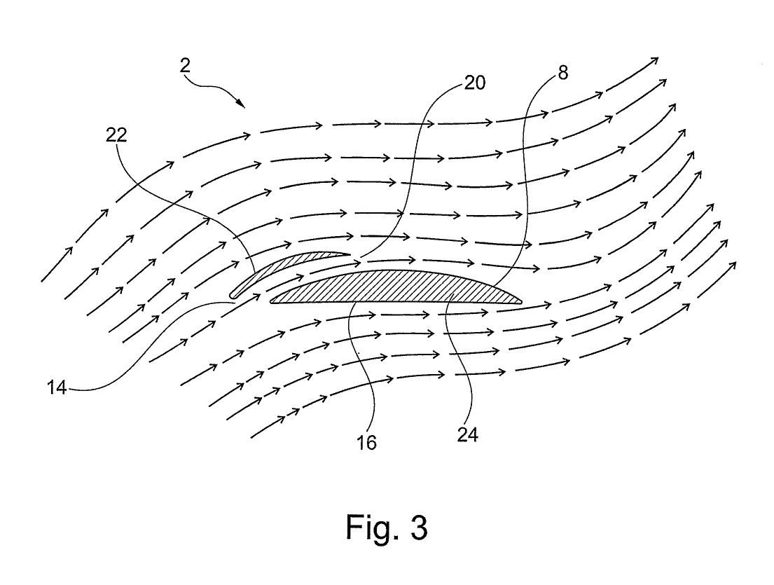

FIG. 3 shows a sectional view of the blade 2. The blade 2 has a low pressure side 8 and a high pressure side 16. The inlet 14 for the channel 18 continues into the outlet 20. The blade 2 is in the shown section formed of a secondary blade section 22 and a primary blade section 24 where the channel 18 is formed between the blade sections 22, 24.

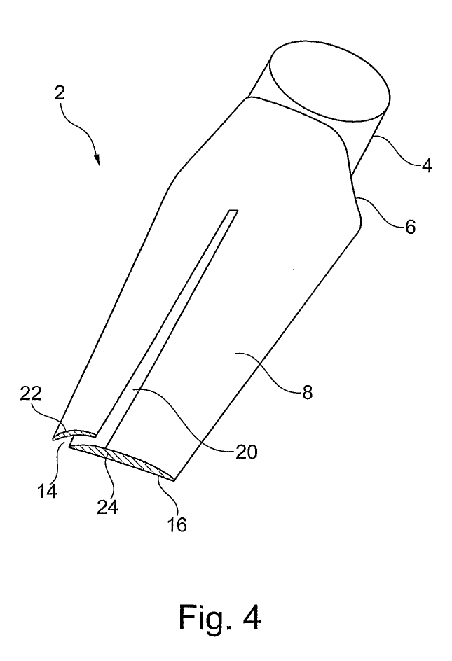

FIG. 4 shows the blade 2 with the hub connection 4 and the transition area 6. This figure further shows the low pressure side 8 of the blade 2 and the pressure side 16 of the blade 2. The channel 18 has an inlet 14 and an outlet 20. The channel 18 is formed between the secondary blade section 22 and the primary blade section 24.

In operation, air or water will flow around the blade 2 and thereby create the driving force for the wind or water turbine, where the wind or water turbine then converts the wind or water energy into power that can be used, stored or transmitted. In the central part of this blade 2 shown in the drawings, there is a channel 18. This channel 18 starts approximately at the end of the transition area 6; also in the inner part of the blade 2 where only a small effect is usually achieved as the inner part of the blade 2 is rotating very slowly. Compensation for this slow rotation is performed by using the channel 18 having the inlet 14 and the outlet 20. Inside this channel 19, the air or water stream will increase its velocity simply because the inlet 14 has a bigger open area than the outlet 20. This increasing air or water velocity will result in higher power consumption. The higher air or water speed will increase the forces acting on the blade. By using this channel 18 in the inner part of a blade 2, the power production of a blade 2 can be increased by up to 20%.

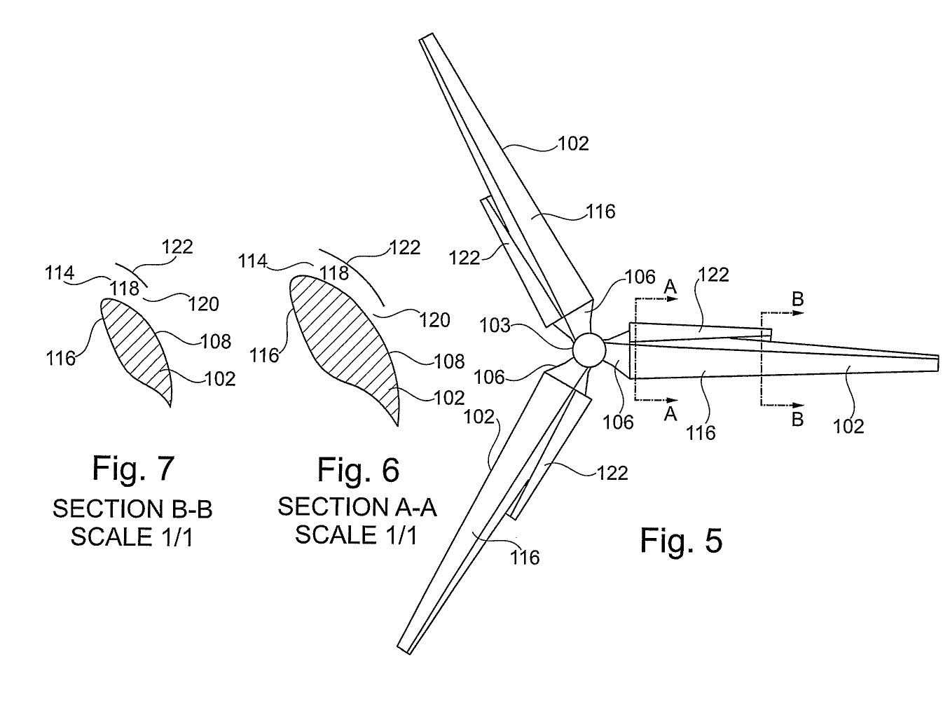

FIG. 5 shows three blades 102 which are connected to a hub 103. The blade 102 comprises a transition area 106 between the blade itself and the hub 103. The blades 102 are seen from their pressure side 116. A secondary blade 122 is fixed to the blade 102 from the transition area and outwards along the blade. The blade 122 ends nearly halfway along the main blade 102.

Furthermore, FIG. 6 shows a sectional view A-A of the blade 102 as seen in FIG. 5. At FIG. 6, the blade 102 comprises a low pressure side 108 and a pressured side 116. A channel inlet 114 is indicated towards a channel 118 and also a channel outlet 120. The channel 118 is formed because a secondary blade 122 is placed in a distance from the main blade 102.

FIG. 7 shows the same elements as previously described in FIG. 6. Only points of difference between the two figures will be mentioned. FIG. 7 is a sectional view B-B near the end of the secondary blade 122. Compared to FIG. 6, it is clearly seen that also the main blade 102 has a reduced sectional area. The blade 122 is reduced a lot in size, and the distance towards the main blade 102 is increasing. The channel 118 is as such much shorter but also has a much larger opening area. This has been made because the media speed is much higher as the rotational speed of the blade is much higher so much longer from the hub 103.

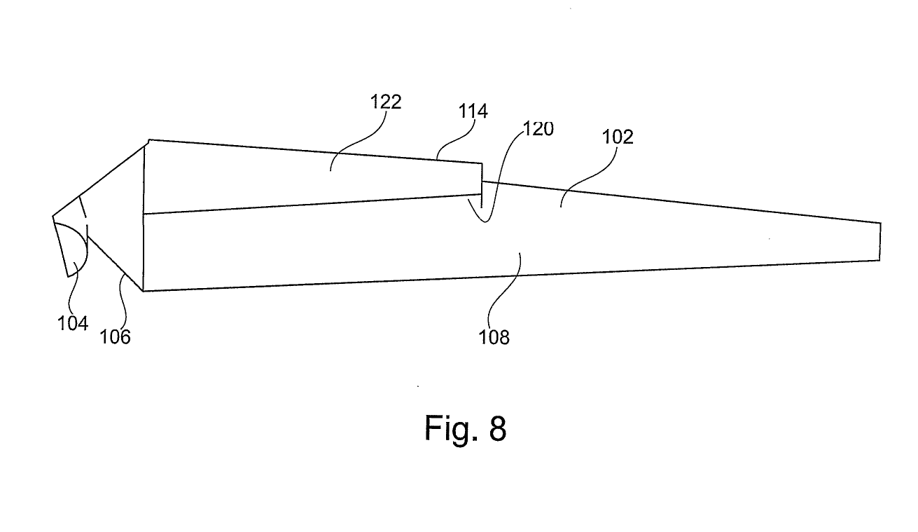

FIG. 8 shows a blade 102 seen from the low pressure side 108. The blade 102 is connected to a root connection 104 by a transition area 106. At the low pressure side 108, the secondary blade 122 is seen which has an inlet 114 and an outlet 120. It is here to be seen that the blade 122 is decreasing in size in the direction of the blade.

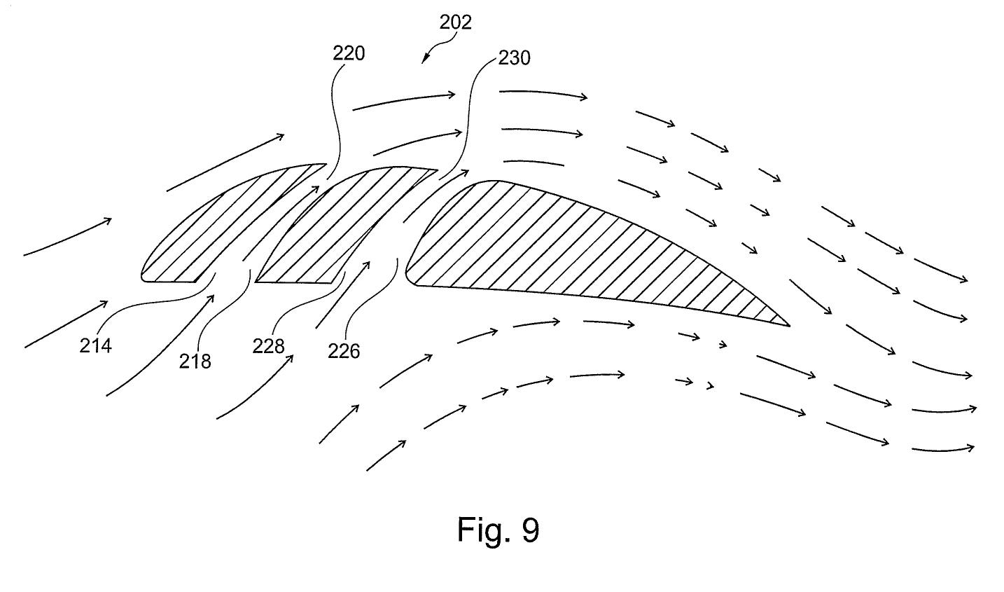

FIG. 9 shows an alternative embodiment to the invention in that a blade 202 comprises two channels 218 and 226. The first channel 218 has an inlet 214 and an outlet 220. Furthermore, the channel 226 has an inlet 228 and an outlet 230. Both channels 218 and 226 are designed so that the distance between the walls is decreasing from the inlets 214,228 towards the outlets 220,230. This will lead to an increasing media velocity in the channels and thereby a much higher energy consumption from the media. In fact, the fast flowing media will act at three different surfaces and at the same time, the two outlets 220, 230 will result in deflection of the media streaming around the blade. This deflection will act as if the blade was much bigger than it is, and therefore increase the power consumption.

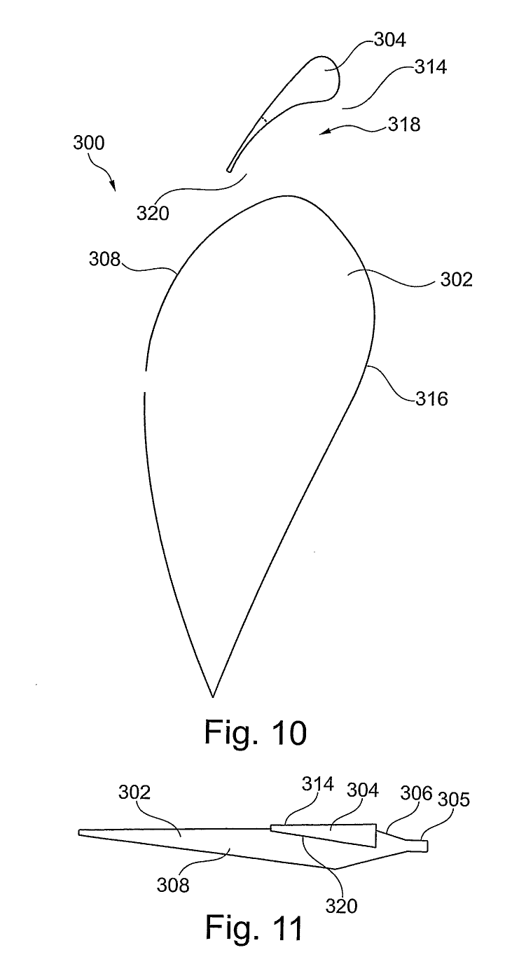

Furthermore, FIG. 10 shows a sectional view of an alternative embodiment for a blade 300. At FIG. 10, the blade 300 comprises a low pressure side 308 and a pressured side 316. A channel inlet 314 is indicated towards a channel 318 and also a channel outlet 320. The channel 318 is formed because a secondary blade 304 is placed in a distance from the main blade 302.

FIG. 11 shows a blade 300 seen from the low pressure side 308. The blade 300 is connected to a root connection 305 by a transition area 306. At the low pressure side 108, the secondary blade 304 is seen which has an inlet 314 and an outlet 320. It is here to be seen that the blade 304 is decreasing in size in the longitudinal direction of the blade away from the root connection 305.

1. Blade for a rotor of a wind or water turbine, which rotor comprises a hub, from which hub at least one blade (2,102,300) extends substantially radially, which blade (2,102,300) comprises a root area (4,104,305) closest to the hub, which blade (2,102,300) comprises away from the hub a transition area, (6,106,306) which blade (2,102,300) comprises a pressure side (16,116,316) and a low pressure side (8,108,308), wherein at least one longitudinal channel (18,118,218,226,318) is formed between the pressure side (16,116,316) of the blade (2,102,300) and the low pressure side (8,108,308) of the blade (2,102,300), which channel (18,118,218,226,318) comprises at least one inlet opening (14,114,214,228,314) in the pressure side (16,116,316) of the blade (2,102,300), and which channel (18,118,218,226,318) comprises at least one outlet opening (20,120,220,230,320) in the low pressure side (16) of the blade (2,102,300), which channel (18,118,218,226,318) comprises an opening area, which opening area is decreasing from the inlet opening (14,114,214,228,314) to the outlet opening (20,120,220,230,320).

2. Blade according to claim 1, wherein the channel (18,118,318) is formed between a secondary blade (22,122,304) and the main blade (2,102,302), which secondary blade (22,122,304) is placed at the front of the main blade 2,102,302) at the low pressure side (8,108,308) of the main blade (2,102,302).

3. Blade according to claim 1, wherein the blade (2,102,302) comprises at least one longitudinal channel (18,118,218,226,318) between the pressure side (16,116,316) of the blade (2,102,302) and the low pressure side (8,108,308) of the blade (2,102,302), which channel (18,118,218,226,318) comprises an inlet opening (14,114,214,228,314) in the pressure side (16,116,316) of the blade (2,102,202,302), which channel (18,118,218,318) has an outlet opening (20,120,220,230,320) in the low pressure side (16,116,316) of the blade, which channel (18,118,218,226,318) opening area is decreasing from the inlet opening (14,114,214,228,314) to the outlet opening (20,120,220,230,320).

4. Blade according to claim 1, wherein the channel (18,118,218,228) starts near the root (4,104,305) of the blade (2,102,300) and continues to the end (10) of the blade (2,102,300).

5. Blade according to claim 1, wherein the channel (18,118,218,226,318) starts near the root (4,104,305) of the blade (2) and continues to at least ⅔ of the length of the blade (2).

6. Blade according to claim 1, wherein the channel (18,118,218,228) starts near the root (4,104,305) of the blade (2,102,300) and continues to at least the middle of the length of the blade (2,102,300).

7. Blade according to claim 3, wherein the blade (2) comprises at least a first (18,218) and second (26,226) parallel longitudinal channels.

8. Blade according to claim 2, wherein the channel (118,318,) is formed by a main blade (124,302) and at least one secondary blade (122,304), between which main (124,302) and secondary blade (122,304) the channel (118,318) is formed.

9. Blade according to claim 7, wherein the distance between the main blade (124,302) and the secondary blade (122,304) is decreasing from the inlet (114,314) towards the outlet opening (120,320).

10. Method for converting energy from a flow in a media into rotational energy by using at least one blade (2,102,300), which blade (2,102,300) rotates around an axis, which blade (2,102,300) is formed in radial direction in relation to the rotating axis, which blade (2,102,300) comprises a pressure surface (16,116,316) at which pressure surface (16,116,316) the flowing media generates a pushing force at this pressure surface (16,116,316), and where the blade (2,102,300) comprises a low pressure surface (8,108,308), where at the low pressure surface (8,108,308) the media generates a pulling force, wherein at least one channel (18,118,218,226) is formed in relation to the blade (2,102,300), which channel (18,118,218,226) has an inlet (14,114,214,228,314) at the pressure side (16,116,316) of the blade (2,102,300) and where the channel (18,118,218,226,318) has an outlet in the low pressure side (8,108,308).
